(19) United States
(12) Patent Application Publication
(10) Pub. No.: US 2015/0004529 A1
(43) Pub. Date: Jan. 1, 2015

(54) Chemical Vapour Deposition of PTSI from Organometallic Complexes of PT

(71) Applicants: COMMISSARIAT A L'ENERGIE ATOMIQUE ET AUX ENERGIES ALTERNATIVES, Paris (FR); CENTRE NATIONAL DE LA RECHERCHE SCIENTIFIQUE, Paris (FR); UNIVERSITE CLAUDE BERNARD LYON I, Villerubanne Cedex (FR)

(72) Inventors: Sebastien Donet, Meaudre (FR); Christophe Coperet, Zurich (CH); Nicolas Guillet, Pizancon (FR); Pierre Laurent, Lyon (FR); Chloe Thieuleux, Villeurbanne (FR)

(21) Appl. No.: 14/372,908

(22) PCT Filed: Jan. 16, 2013
(86) PCT No.: PCT/IB2013/050397

§ 371 Date: Jul. 17, 2014

(30) Foreign Application Priority Data
Jan. 17, 2012 (FR) 1250458

(51) Int. Cl. H01M 4/90; H01M 4/88; H01M 8/10

(52) U.S. Cl. CPC H01M 4/9008; H01M 8/10; H01M 4/8867; H01M 4/8807; H01M 4/9041
USPC 429/524; 427/126.1; 427/126.2; 427/113; 502/262

(57) ABSTRACT

The present invention relates to the use, as a precursor for the chemical vapour deposition of PtSi at the surface of a support, of at least one organometallic complex of Pt comprising at least:—a ligand having a cyclic structure that comprises at least two non-adjacent C═C double bonds, or two ligands having a cyclic structure that each comprise a C═C double bond; and—a ligand chosen from *O—Si(R)₃ and *N—(Si(R)₃)₂, with: the R units being chosen, independently of one another, from (C₁-C₄)alkoxy groups; the R′ units being chosen, independently of one another, from (C₁-C₄)alkyl and (C₃-C₄)cycloalkyl groups; and * representing the coordination of the ligand to the platinum.

The present invention relates to the field of supported catalytic layers. It has more particularly as subject matter the use of organometallic platinum (Pt) complexes for the chemical vapor deposition of PtSi at the surface of a support.

Platinum-based catalytic layers find applications in multiple fields, for example the catalysis of air (treatment of pollutants: volatile organic compounds (VOCs), nitrogen oxides (NOx)), the generation of hydrogen by reforming hydrocarbons or biofuels or the storage of hydrogen by adsorption, the filtration of water, and the like.

They are more particularly employed to form the active part of the electrodes of proton exchange membrane fuel cells (PEMFCs). This is because the catalytic layer constitutes an essential component in the membrane-electrode assembly. The electrodes of fuel cells are the site of electrochemical reactions (oxidation of hydrogen at the anode and reduction of oxygen at the cathode), said reactions only being possible in the presence of a catalyst. In practice, such electrodes comprise a support used for the mechanical strength comprising at least one electron-conducting microporous layer, also known as diffusion layer, which layer is covered with a catalytic layer, and in contact with a proton conductor (generally an ionomer).

Currently, the catalyst generally employed is platinum, which is made use of in the form of spherical particles, the diameter of which is of the order of a few nanometers. These catalyst particles are deposited on carbon particles, the diameter of which is of the order of a few tens of nanometers (20 to 80 nm inclusive), which can exist in the form of agglomerates. The assembly is generally referred to as “platinized carbon” or “Pt/C”.

Usually, the active layers are made in two different ways:

the ionomer and the platinized carbon are suspended in solvents. This suspension, known as ink, is subsequently deposited on the membrane or on the diffusion layer in order to form the active layers after evaporation of the solvents; or

the ionomer is impregnated (for example by spraying) over a premanufactured porous layer comprising the platinized carbon and a non-proton-conducting polymer binder.

The best active layers of Pt nanoparticles, produced by conventional techniques, exhibit an electroactive surface area of approximately 250 cm² of Pt per 1 cm² of geometric surface area (in other words, a roughness factor of 250) and comprise approximately 0.4 mg Pt/cm², i.e. an electroactive surface area by weight of the order of 65 m²/g of Pt.

Due to the high cost of platinum, the formulation of catalytic layers with low platinum loads is included as one of the key factors in the development of fuel cells of PEMFC type. Thus, one of the continual concerns in the preparation of catalytic layers is to increase the electroactive surface area for a given geometric surface area and a given platinum loading, in order to obtain the most advantageous performance.

From this perspective, various routes for the preparation of catalysts, supported or nonsupported, have been explored for the purpose of optimizing the degree of Pt loading and the structure of the electrodes.

Mention may be made, by way of example, of the preparation by Debe et al. [1] of nanostructured electrodes obtained from the deposition of Pt on organic whiskers. This method exhibits the advantage of being able to control the platinum content. However, the whiskers, which are electrical insulators, remain in the electrodes and the conduction of the electrons is provided by the catalyst. There is no impregnation of the ionomer at the surface of the catalyst in order to retain the porosity of the layer (number of triple points). Consequently, not all the platinum is in contact with the ionomer and thus not all is used during the electrochemical reactions. The electroactive surface area by weight obtained with this method is 10 m²/g, a lower value than that of the electrodes currently marketed.

Equally, many studies relate to the preparation of modified supports using carbon nanotubes instead of spherical carbon particles as catalyst support ([2], [3]). These supports advantageously exhibit an improved chemical stability and make it possible to obtain a different nanostructure from that obtained with spherical carbon-based supports. Nevertheless, as the catalyst exists in the form of supported Pt particles, these active layers exhibit the same disadvantages as the layers currently marketed.

Mention may also be made of the study by Gasteiger et al. [4] targeted at improving the use of the Pt by controlling the size of the particles while localizing them over a thickness of a few micrometers. It is thus possible to increase the electroactive surface area by weight to 76 m²/g with a loading of 0.1 mg/cm². This method is suitable for the manufacture of an anode for which the amount of platinum necessary for the chemical reactions is low.

As regards the nonsupported catalysts, mention may be made of the preparation by Choi et al. [5] of electrodes with a nonsupported catalyst by employing platinum nanowire electrodes. The idea is based on the fact of using elongated catalyst structures instead of spherical catalyst structures in order to increase the electroactive surface area by weight. However, this method results in an electroactive surface area by weight of Pt of 2 m²/g, which is not satisfactory from the view point of the values obtained with conventional catalytic layers.

The present invention is targeted at providing for the preparation of a novel catalytic layer exhibiting an increased electroactive surface area for a given Pt loading.

In particular, it provides for the formation of a PtSi-based catalytic layer by chemical vapor deposition at the surface of a support starting from one or more organometallic Pt complexes.

The present invention thus relates, according to a first of its aspects, to the use, as precursor for the chemical vapor deposition of PtSi on the surface of a support, of at least one organometallic Pt complex comprising at least:
one ligand having a cyclic structure and comprising at least two nonadjacent C═C double bonds, or two ligands having a cyclic structure and each comprising a C═C double bond; and
one ligand chosen from:

*O—Si(R)₃ and *N—(Si(R′)₃)₂
with:
the R units being chosen, independently of one another, from (C₁-C₄)alkoxy groups;
the R′ units being chosen, independently of one another, from (C₁-C₄)alkyl and (C₃-C₄)cycloalkyl groups; and
*representing the coordination of the ligand to the platinum.

It also relates, according to another of its aspects, to a process for the formation of a PtSi-based catalytic layer at the surface of a support, comprising at least one stage of chemical vapor deposition of PtSi at the surface of said support, starting from one or more organometallic Pt compounds as defined above.

Chemical vapor deposition (CVD), in particular starting from organometallic compounds (MOCVD or Metallo-Organic Chemical Vapor Deposition), is a well known technique for obtaining controlled depositions of good quality. This technique is in particular preferred to impregnation by the liquid route, which requires a large amount of deposited material, is capable of bringing about nonhomogeneity in deposition due to the flow of liquid and requires a heat treatment (drying and calcination) stage. Generally, MOCVD consists in vaporizing a volatile precursor of the metal, namely an organometallic complex, which will decompose thermally over the substrate to form a metal layer. For example, the deposition by CVD of a film or of particles of Pt over a support starting from organometallic Pt complexes is described in the document FR 2 940 980.

However, to the knowledge of the inventors, it has never been proposed to obtain a PtSi-based catalytic layer by MOCVD starting from organometallic Pt complexes according to the invention.

The present invention is also targeted, according to another of its aspects, at a support exhibiting a PtSi-based catalytic layer, characterized in that at least 20% by weight, preferably at least 40% by weight, of the Pt forming the electroactive surface of said layer is present therein in a form coordinated to silicon.

According to yet another of its aspects, the present invention relates to a support exhibiting a PtSi-based catalytic layer obtained according to the process described above.

As demonstrated by the tests which follow, the inventors have found that it is possible to access, according to the invention, a PtSi-based catalytic layer exhibiting particularly advantageous catalytic properties, in particular with a view to its use in proton exchange membrane fuel cells (PEMFCs).

Advantageously, the PtSi-based catalytic layer according to the invention exhibits an electroactive surface area by weight of greater than or equal to 500 cm²/mg, preferably of greater than or equal to 800 cm²/mg.

A PtSi-based catalytic layer according to the invention finds application more particularly in proton exchange membrane fuel cells.

Thus, according to yet another of its aspects, the present invention relates to a proton exchange membrane fuel cell, comprising a support exhibiting a catalytic layer as defined above. The support more particularly forms all or part of one or more electrodes of said cell, in particular the anode.

The invention thus makes it possible to obtain electrodes for PEMFC cells having a high electrocatalytic reactivity and exhibiting a reduced platinum loading, thus making possible a reduction in cost.

Thus, a PEMFC cell incorporating a catalytic layer according to the invention may exhibit a degree of platinum loading of less than or equal to 0.05 g Pt/A, preferably of less than or equal to 0.02 g Pt/A.

In addition, as expanded upon subsequently, the CVD deposition starting from the organometallic complexes of the invention may be carried out at lower temperatures than those normally used in MOCVD techniques. More particularly, for the CVD deposition, the substrate to be treated may be brought to a temperature ranging from 150 to 380° C. Such a reduced temperature makes it possible to envisage the use of substrates of varied natures, in particular of more fragile substrates.

Other characteristics, alternative forms and advantages of the formation of a PtSi-based catalytic layer according to the invention will emerge better on reading the description, examples and figures which will follow, given by way of illustration and without implied limitation.

In the continuation of the text, the expressions “of between . . . and . . . ”, “ranging from . . . to . . . ” and “varying from . . . to . . . ” are equivalent and are understood as meaning that the limits are included, unless otherwise mentioned.

Unless otherwise indicated, the expression “comprising a” should be understood as “comprising at least one”.

In the continuation of the text, chemical vapor deposition starting from the complexes of the invention will be denoted without distinction by the abbreviation “CVD” or the abbreviation “MOCVD”.

Organometallic Complex

As specified above, the present invention employs organometallic Pt complexes comprising at least:
one ligand having a cyclic structure and comprising at least two nonadjacent C═C double bonds, or two ligands having a cyclic structure and each comprising a C═C double bond; and
one ligand chosen from:

*O—Si(R)₃ and *N—(Si(R′)₃)₂
with:
the R units being chosen, independently of one another, from (C₁-C₄)alkoxy groups, being in particular tributoxy groups;
the R′ units being chosen, independently of one another, from (C₁-C₄)alkyl and (C₃-C₄)cycloalkyl groups, in particular from (C₁-C₄)alkyl groups and more particularly being methyl groups; and
*representing the coordination of the ligand to the platinum.

The term “(C₁-C₄)alkoxy group” is understood to mean an —O—(C₁-C₄)alkyl group.

The term “(C₁-C₄)alkyl group” is understood to mean a saturated and linear or branched aliphatic group comprising from 1 to 4 carbon atoms.

The term “(C₃-C₄)cycloalkyl group” is understood to mean a cyclic alkyl group comprising 3 or 4 carbon atoms.

The Pt within the organometallic complex is more particularly bonded to each of the C═C double bonds of the ligand.

According to a specific embodiment, an organometallic complex according to the invention comprises just one ligand having a cyclic structure and comprising at least two nonadjacent C═C double bonds.

In particular, it is a 1,5-cyclooctadiene ligand (denoted “cod”).

According to another specific embodiment, an organometallic complex according to the invention comprises at least two ligands having a cyclic structure and each comprising a C═C double bond. They may, for example, be two cyclooctene ligands.

According to a specific embodiment, the organometallic complex may be of following formula (I):

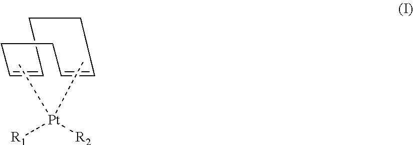

in which at least one of the R₁ and R₂ groups is a ligand chosen from:

*O—Si(R)₃ and *N—(Si(R′)₃)₂

with:

the R units being chosen, independently of one another, from (C₁-C₄)alkoxy groups;

the R′ units being chosen, independently of one another from (C₁-C₄)alkyl and (C₃-C₄)cycloalkyl groups, in particular from (C₁-C₄)alkyl groups; and

*representing the coordination of the ligand to the platinum.

According to a specific embodiment, the organometallic complex employed according to the invention comprises two ligands chosen from *O—Si(R)₃ and *N—(Si(R′)₃)₂, R and R′ being as defined above.

Preferably, the two ligands are of the same nature.

In particular, the ligand can be chosen from *O—Si(OtBu)₃ and *N-(TMS)₂, with TMS representing trimethylsiloxane.

An organometallic complex according to the invention may comprise a ligand other than the abovementioned ligands *O—Si(R)₃ and *N—(Si(R′)₃)₂. It may in particular be a ligand of halogen type, such as, for example, a chlorine atom.

According to a specific embodiment, the organometallic complex is (cod)Pt(OSi(OtBu)₃)₂.

According to another specific embodiment, the organometallic complex is (cod)Pt(Cl)(N(TMS)₂).

The organometallic complexes may be synthesized by methods of synthesis known to a person skilled in the art and more particularly expanded upon in example 1.

By way of example, the complex (cod)Pt(OSi(OtBu)₃)₂ may be synthesized by reaction of (tBuO)₃SiONa with (cod)PtCl₂, according to a method similar to that described in the publication Ruddy et al. [6].

Advantageously, as illustrated in the following example 1, the organometallic complexes according to the invention are capable of decomposing at a temperature of less than 200° C., in particular of less than 150° C., in particular of approximately 130° C.

Such a decomposition temperature makes it possible to envisage CVD deposition by heating the substrate to be treated to temperatures lower than those normally employed for CVD depositions, as expanded upon below.

Support

The support on which the catalytic layer according to the invention is formed depends, of course, on the application envisaged.

It may in particular be a ceramic, a heat-resistant polymer, a glass, a perovskite, such as LaAlO₃, Si, SiC or a textile comprising a microporous carbon-based surface layer.

Preferably, the support may be a carbon-based support, in particular a porous carbon-based support.

The porous support may more particularly be a filtering support for the catalysis, such as a foam or honeycomb. It may exhibit a porosity of from 2 to 600 cpsi (channels per square inch) and/or from 2 to 60 ppi (pores per square inch).

The support may also be a support of gas diffusion layer (GDL) type, normally employed for fuel cells.

The GDL is generally composed of a fibrous structure treated with a hydrophobic material, or a silica wafer, of glass layers or also of a structure of honeycomb cell type.

Of course, the support employed according to the invention may comprise one or more intermediate layers, chosen in particular from: metal films, an organic layer, diffusion layers, for example composed of at least one material chosen from carbon, graphite or nanotubes.

CVD Process

Chemical vapor deposition (CVD) may be carried out by any method known to a person skilled in the art.

As mentioned above, chemical vapor deposition comprises at least two stages: a first stage of bringing the precursor into the vapor phase under conditions which do not effect its stability and a second stage of decomposition of the precursor over a support.

Specific features of the CVD process which may be employed are given below, solely as nonlimiting examples.

Deposition by DLI-MOCVD

According to a particularly preferred embodiment, the deposition by CVD is carried out by a direct liquid injection metal organic chemical vapor deposition (DLI-MOCVD) process.

The principle of DLI-MOCVD results from the conventional CVD systems. This principle is, for example, described in the document WO 2007/088292. Generally, the organometallic complexes are introduced in liquid form and injected at high pressure by injectors. The organometallic complexes are thus introduced into the deposition chamber in which the support to be treated is found. The complexes are then subjected to a decomposition which results in the formation of the deposit on said support.

This process advantageously makes it possible to control the morphology of the particles as a function of the CVD parameters (weight of product injected, frequency of injection, duration of the deposition) and makes possible easy implementation on an industrial scale.

FIG. 1 diagrammatically represents a standard device for deposition by DLI-MOCVD.

Such a device is more particularly formed of a tank for storage of the solution of precursors (1), an injector (2) connected to the liquid tank via a feedline, a feedline for carrier gas, for example N₂, an evaporator (7) and a gas distribution system (4). The deposition chamber (5), which comprises the support to be treated (6), comprises a heating system, a gas feed (3) and pumping and pressure-regulating means.

Said organometallic complex or complexes may be dissolved beforehand in a solvent suitable for the process, in particular a solvent which reacts neither with the precursor nor with the support. For example, it may be toluene.

It is up to a person skilled in the art to adjust the conditions for deposition by DLI-MOCVD, such as, for example, the concentration of organometallic complexes in the solution, the pressure and temperature conditions, the nature of the reactive gas, in particular from the viewpoint of the nature of the substrate, of the surface to be treated, of the thickness of the catalytic layer desired, and the like.

In practice, the vaporization takes place under pressure and temperature conditions which make it possible to obtain a vapor pressure of the precursor sufficient for the deposition, while remaining within its stability range. The substrate, for its part, is heated beyond the stability range, which makes possible the decomposition of the organometallic complex and the formation of the catalytic layer.

In particular, the chamber can be placed:

under a neutral atmosphere, in particular using a gas chosen, for example, from N₂, Ar or He, or

under an atmosphere of oxygen, optionally as a mixture with a neutral gas, such as nitrogen, the oxygen having the advantage of promoting the combustion of the organic matter, or

under a hydrogen atmosphere, which promotes the decomposition and influences the size and the shape of the crystallites, or

under an ozone atmosphere.

Preferably, the chemical vapor deposition is carried out in a chamber under an O₂+N₂ atmosphere, for example an atmosphere formed of 20% by weight of N₂ and 80% by weight of O₂.

According to a specific embodiment, the chemical vapor deposition is carried out at a pressure ranging from 1 mbar to 150 mbar, in particular from 1 to 5 mbar.

As mentioned above, the temperature to which the substrate to be treated is brought is always greater than or equal to the decomposition temperature of the precursor.

As mentioned above, the substrate for the CVD deposition starting from the organometallic complexes according to the invention can be heated to a temperature ranging from 150° C. to 380° C., in particular to a temperature of less than or equal to 300° C., in particular to a temperature of less than or equal to 270° C.

By way of example, in a device as represented in FIG. 1, the substrate (6) may be brought to a temperature of approximately 270° C., the evaporator (7) to approximately 100° C. and the gas distribution system (4) to approximately 130° C.

Different conditions may make it possible to promote the deposition over the substrate, in particular with respect to deposition on the walls of the chamber.

For example, according to a specific embodiment, a reactive gas may be injected into the deposition chamber in order to promote the decomposition of the precursor (ALD (atomic layer deposition) process).

According to another specific embodiment, the support may be subjected to at least one activation of its surface to be treated, in order to create hydroxyl bonds which make it possible to adjust the intensities of the surface anchoring sites.

This activation may more particularly consist of a thermal activation, an activation by laser (LCVD), an activation by UV, an activation by plasma (PECVD), an activation by ion beams or an activation by an electron beam (EBCVD). Such an activation is more particularly carried out simultaneously with the deposition.

Of course, several activation methods may be combined with one another in order to exert better control over the quality of the deposition.

Of course, other alternative forms for the deposition by CVD according to the invention may be envisaged, provided that they are not prejudicial to the formation of the PtSi catalytic layer according to the invention.

Catalytic Layer

The treatment by CVD starting from one or more organometallic complexes according to the invention makes it possible to obtain a PtSi-based catalytic layer.

In particular, at least 20% by weight, in particular at least 40% by weight, of the platinum forming the electroactive surface of said layer is present therein in a form coordinated to silicon.

Advantageously, the catalytic layer formed exhibits a homogeneous thickness and a homogeneous structure.

Of course, the thickness of the catalytic layer formed on the support depends on the conditions employed for the CVD deposition, in particular, for a deposition by DLI-MOCVD, on the concentration of precursor employed, on the duration of vaporization and on the respective temperatures in the reactor and of the support.

According to a specific embodiment, the catalytic layer obtained may exhibit a thickness ranging from 2 to 25 nm, in particular from 2 to 20 nm.

More particularly, the platinum of the catalytic layer formed exists in the form of particles of nanometric size coordinated to Si particles of nanometric size dispersed at the surface of the substrate.

The Pt and Si nanoparticles may more particularly exhibit a size ranging from 1 to 100 nm in diameter, in particular from 1 to 10 nm and more particularly from 4 to 8 nm.

As mentioned above, the PtSi-based layer formed according to the invention exhibits excellent catalytic properties.

In particular, the catalytic layer formed according to the invention may exhibit an electroactive surface area ranging from 500 to 800 cm² Pt/cm² of surface of the treated support.

The platinum loading may be between 2 and 7 μg Pt/cm² of the surface of the treated support.

Particularly advantageously, the catalytic layer according to the invention may thus exhibit an electroactive surface area by weight of greater than or equal to 500 cm²/mg of Pt.

Preferably, the electroactive surface area by weight of said catalytic layer obtained according to the process of the invention is greater than or equal to 600 cm²/mg of Pt, in particular greater than or equal to 700 cm²/mg and more preferably greater than or equal to 800 cm²/mg of Pt.

As specified above, a PtSi-based catalytic layer according to the invention finds application more particularly in the field of the manufacture of proton exchange membrane fuel cells (PEMFCs).

The support exhibiting a catalytic layer according to the invention may more particularly form all or part of one or more electrodes of said cell, in particular the anode.

The degree of platinum loading for the electrode may advantageously be less than or equal to 0.05 g Pt/A, preferably less than or equal to 0.04 g Pt/A, in particular less than or equal to 0.03 g Pt/A and more preferably less than or equal to 0.02 g Pt/A.

Of course, the use of a catalytic layer according to the invention is in no way limited to an application for fuel cells of PEMFC type but said layer may be used for any other application of the catalytic layers, for example for devices for the catalysis of air, for the generation of hydrogen by reforming of hydrocarbons or of biofuels, for the storage of hydrogen by adsorption or for water filtration.

The invention will now be described by means of the following examples and figures which illustrate the implementation of the process of the invention.

These examples and these figures are, of course, given by way of illustration and without implied limitation of the invention.

### FIGURES

FIG. 1: diagrammatic representation of the device for the deposition by DLI-MOCVD.

FIG. 2: thermogravimetric analysis of the precursor (cod)Pt(OSi(OtBu)₃)₂ under N₂ (30 ml/min), heating at 10° C./min.

FIG. 3: TEM image of a catalytic layer according to the invention (FIG. 3a) and size distribution diagram drawn up from the TEM analysis (FIG. 3b).

FIG. 4: EDX spectrum for a catalytic layer according to the invention.

### EXAMPLES

### Example 1

Syntheses of Organometallic Platinum Complexes

i. Synthesis of the (cod)Pt(OSi(OtBu)₃)₂ Complex

The (cod)Pt(OSi(OtBu)₃)₂ complex is synthesized according to a protocol similar to that described in the reference [6], apart from the difference that the sodium salt (tBuO)₃SiONa is used in place of the potassium salt (tBuO)₃SiOK.

This complex is formed by reaction of (tBuO)₃SiONa with (cod)PtCl₂.

In a first step, the compound (tBuO)₃SiONa is synthesized from (tBuO)₃SiOH and sodium in pentane.

Moreover, (cod)PtCl₂ is synthesized from K₂PtCl₄ and cod.

Analysis

The thermogravimetric analysis of the precursor (cod)Pt(OSi(OtBu)₃)₂, carried out under N₂ (30 ml/min) and heating at 10° C./min, is presented in FIG. 2.

It shows that the beginning of the decomposition of this complex takes place at approximately 130° C.

ii. Synthesis of the (cod)Pt(Cl)(N(TMS)₂) Complex

This complex is synthesized according to a protocol similar to that described by Wendt et al. [7], by reaction between LiN(TMS)₂ and CodPtCl₂.

### Example 2

Formation of an Active Layer by DLI-MOCVD

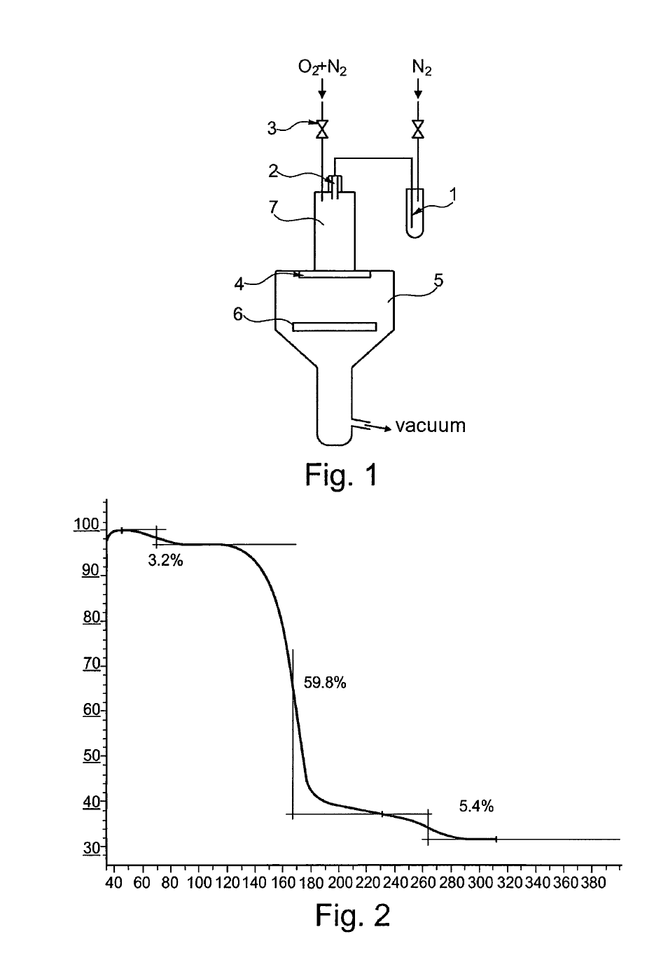

The (cod)Pt(OSi(OtBu)₃)₂ complex prepared according to example 1 was deposited according to a direct liquid injection metal organic chemical vapor deposition (DLI-MOCVD) process using a device as represented diagrammatically in FIG. 1 and according to the protocol described in detail below.

Support

The deposition is carried out on substrates of gas diffusion layer (GDL) type. The GDL exhibits a microporous structure formed of particles of carbon and of polytetrafluoroethylene (PTFE) which are supported on a carbon substrate. The GLDs used are those sold under the references 24 BC by SGL Group (Carbon Company) and ETEk by BASF.

DLI-MOCVD Protocol

The deposition by DLI-MOCVD is carried out according to the following protocol:

the samples are cleaned: 15 minutes under ultrasound in acetone, rinsing with ethanol and drying with compressed air.

the samples are placed on the substrate holder, the monitoring thermocouples are installed and the reactor is closed.

the reactor is placed under vacuum.

once the limiting vacuum has been reached, a leakage test is carried out on the reactor: 1 mbar in 5 min.

the evaporator is heated to 100° C., along with the evaporator-deposition chamber connections.

the vessel is filled with the precursor liquid (0.025 mol/l⁻¹ of said organometallic precursor dissolved in toluene), the line is purged and then the vessel is pressurized (4 to 6 bar) by acting on the three-way valves of the precursor vessels.

the temperature set points are 100° C. for the evaporator, 130° C. for the gas distributor and 270° C. for the sample holder. Once the operating pressure has been reached (1 torr with 20% N₂+80% O₂) and the set point temperatures have been reached, it is advisable to observe a stationary phase of a minimum of 15 minutes in order to obtain good thermal homogeneity.

the injection parameters are seized on: 2 ms at 2 Hz. The gas and liquid pneumatic valves are opened.

after the deposition phase, the controller changes to “cooling” mode.

when the temperature of the reactor is sufficiently low, the controller allows the product to be removed from the chamber.

Analysis of the Catalytic Layer Formed

TEM Analysis

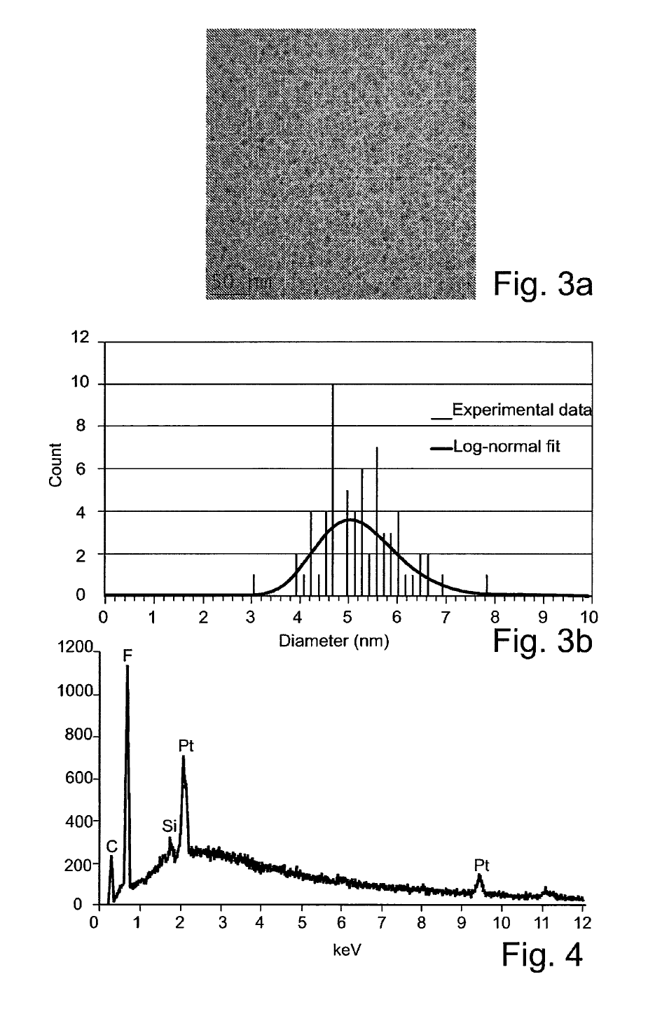

The deposited layers are analyzed by transmission electron microscopy (TEM) using a Jeol 2000FX MET. FIG. 3a represents the image obtained by TEM (120 keV) and FIG. 3b represents the size distribution diagram drawn up from the TEM analysis.

This analysis shows the formation of Pt and Si nanoparticles, with a mean nanometric size ranging from 4 to 6 nm.

EDX Analysis

The energy dispersive (EDX) analysis, represented in FIG. 4, confirms the presence of Pt (2.048 and 9.441 keV) and of Si (1.739 keV). The presence of fluorine (0.677 keV) is related to the PTFE of the GLD support.

### Example 3

Catalytic Properties of the Layer Formed

i. Preparation of the Half-Fuel Cells

The catalytic layers formed on GDLs as described in example 2 are tested within a membrane-electrode assembly (MEA).

The MEA is composed of two layers: the proton-conducting membrane (perfluorosulfonated ionomer sold under the Nafion® reference) and the gas diffusion layer comprising the catalyst.

The GDLs as prepared in example 2 are impregnated with a Nafion® solution (0.5% by weight in 1:1 water/isopropanol) using an airbrush (Nafion loading of approximately 100 μg·cm⁻²).

ii. Electrocatalytic Properties

The working electrode incorporating the MEA assembly (active surface area of 0.5 cm²), a reference electrode (Hg/HgSO₄) and a counter electrode (platinum) are introduced into a standard electrolyte of 0.5 mol·l⁻¹ H₂SO₄.

The total number of reactive surface sites may be determined by measurement of the absorption of hydrogen, followed by oxidation. This method is based on the measurement of the charge necessary in order to remove the absorbed H monolayer, according to the reactions:

H⁺+Pt_{surface}+e⁻→H—Pt_{(surface)}

H—Pt_{(surface)}→H⁺+Pt_{(surface)}+e⁻

The electroactive surface area S may be obtained by the following equation:

S=Q_{H}/0.210

0.210 mC·cm⁻² representing the charge necessary to remove an H monolayer per 1 cm² of platinum and Q_{H} (in mC) being measured by integrating the peak of the cyclic voltammogram obtained, corresponding to the desorption of H₂.

Results

The results obtained for different samples are collated in table 1 below. The following values are given with a standard deviation of ±5%.

TABLE 1

| | | Surface of | | | | | | |
|---|---|---|---|---|---|---|---|---|
| | j at 0.8 V | the area of | | | | | Electroactive | |
| | under | the H₂ | | | | | surface area | Degree of |
| | O₂ | peak | Pt | Pt | | | by weight | loading |
| Sample | (μA/cm²) | (mC) | (μg/cm²) | (cm²Pt/cm²) | μA/μgPt | μA/cm²Pt | (cm²/mg) | (g Pt/A) |
| 1 | 128 | 390 | 3.1 | 3.7 | 41.3 | 34.5 | 1193 | 0.024 |
| 2 | 368 | 427 | 3.1 | 4.1 | 118.7 | 90.5 | 1323 | 0.008 |
| 3 | 332 | 436 | 2.1 | 4.2 | 158.1 | 80.0 | 2000 | 0.0061 |
| 4 | 232 | 750 | 2.1 | 7.1 | 110.5 | 32.5 | 3381 | 0.009 |
| 5 | 48 | 185 | 1.8 | 1.8 | 26.7 | 27.2 | 1000 | 0.037 |
| 6 | 56 | 355 | 1.8 | 3.4 | 31.1 | 16.6 | 1889 | 0.032 |

### REFERENCES

[1] Debe et al., “Handbook of Fuel Cells-Fundamentals Technology and Applications”, Chapter 45, John Wiley & Son (2003), 576;

[2] Yin et al., Electrochimica Acta, 52 (2007), 7042;

[3] Shao et al., J. Electrochem. Soc., 153 (2006), A1093;

[4] Gasteiger et al., J. Power Sources, 127, (2004), 162;

[5] Choi et al., Electrochimica Acta, 53, (2008), 5804;

[6] Ruddy et al., Chem. Mater., 2008, 20, 6517-6527;

[7] Wendt et al., Organometallics, 2008, 27, 4541.

1.-19. (canceled)

20. A process for the chemical vapor deposition of PtSi on a surface of a support, using at least one or more organometallic Pt platinum complex comprising at least:
one ligand having a cyclic structure and comprising at least two nonadjacent C═C double bonds, or two ligands having a cyclic structure and each comprising a C═C double bond; and
one ligand chosen from:
*O—Si(R)₃ and *N—(Si(R′)₃)₂
with:
the R units being, independently of one another, from (C₁-C₄)alkoxy groups;
the R′ units being, independently of one another, from (C₁-C₄)alkyl and (C₃-C₄)cycloalkyl groups; and
wherein *represents a coordination of the ligand to the platinum.

21. The process of claim 20, wherein the organometallic compound is of formula (I): 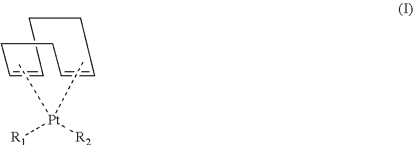
in which at least one of the R₁ and R₂ groups is a ligand chosen from:
*O—Si(R)₃ and *N—(Si(R′)₃)₂
with:
the R units being, independently of one another, from (C₁-C₄)alkoxy groups;
the R′ units being, independently of one another, from (C₁-C₄)alkyl and (C₃-C₄)cycloalkyl groups; and
wherein *represents a coordination of the ligand to the platinum.

22. The process of claim 20, wherein the organometallic compound is (cod)Pt(OSi(OtBu)₃)₂ or (cod)Pt(Cl)(N(TMS)₂).

23. The process of claim 20, wherein the support comprises a ceramic, a heat-resistant polymer, a glass, a perovskite, or a textile comprising a microporous carbon-based surface layer.

24. The process of claim 23, wherein the support comprises LaAlO₃, Si, or SiC.

25. The process of claim 20, wherein the support is a carbon-based support.

26. The process of claim 20, wherein the support comprises one or more intermediate layers further defined as a metal film, an organic layer, or a diffusion layer comprising at least one of carbon, graphite, or nanotubes.

27. A process for the formation of a PtSi-based catalytic layer at a surface of a support, comprising at least one stage of chemical vapor deposition of PtSi at the surface of the support starting from one or more organometallic platinum compound comprising at least:
one ligand having a cyclic structure and comprising at least two nonadjacent C═C double bonds, or two ligands having a cyclic structure and each comprising a C═C double bond; and
one ligand chosen from:
*O—Si(R)₃ and *N—(Si(R′)₃)₂
with:
the R units being, independently of one another, from (C₁-C₄)alkoxy groups;
the R′ units being, independently of one another, from (C₁-C₄)alkyl and (C₃-C₄)cycloalkyl groups; and
wherein *represents a coordination of the ligand to the platinum.

28. The process of claim 27, wherein the chemical vapor deposition is carried out in a chamber under a neutral atmosphere, under an atmosphere of oxygen, under an atmosphere of oxygen mixed with a neutral gas, under a hydrogen atmosphere, or under an ozone atmosphere.

29. The process of claim 27, wherein the chemical vapor deposition is carried out at a pressure ranging from 1 mbar to 150 mbar.

30. The process of claim 27, wherein the chemical vapor deposition is carried out at a temperature ranging from 150° C. to 380° C.

31. The process of claim 27, wherein the support is subjected to at least one activation of its surface to be treated favorable to creating hydroxyl bonds which make it possible to adjust intensities of surface anchoring sites.

32. A support exhibiting a PtSi-based catalytic layer, wherein at least 20% by weight of platinum forming an electroactive surface of the layer is present therein in a form coordinated to silicon.

33. A support exhibiting a PtSi-based catalytic layer obtained according to a process comprising at least one stage of chemical vapor deposition of PtSi at a surface of the support starting from one or more organometallic platinum compound comprising at least:
one ligand having a cyclic structure and comprising at least two nonadjacent C═C double bonds, or two ligands having a cyclic structure and each comprising a C═C double bond; and
one ligand chosen from:
*O—Si(R)₃ and *N—(Si(R′)₃)₂
with:
the R units being, independently of one another, from (C₁-C₄)alkoxy groups;
the R′ units being, independently of one another, from (C₁-C₄)alkyl and (C₃-C₄)cycloalkyl groups; and
wherein *represents a coordination of the ligand to the platinum.

34. The support of claim 33, wherein the catalytic layer has a thickness ranging from 2 to 25 nm.

35. The support of claim 33, wherein the catalytic layer has an electroactive surface area by weight of greater than or equal to 500 cm²/mg Pt.

36. A proton exchange membrane fuel cell, comprising a support exhibiting a catalytic layer obtained according to a process comprising at least one stage of chemical vapor deposition of PtSi at the surface of the support starting from one or more organometallic platinum compound comprising at least:
one ligand having a cyclic structure and comprising at least two nonadjacent C═C double bonds, or two ligands having a cyclic structure and each comprising a C═C double bond; and
one ligand chosen from:
*O—Si(R)₃ and *N—(Si(R′)₃)₂
with:
the R units being, independently of one another, from (C₁-C₄)alkoxy groups;
the R′ units being, independently of one another, from (C₁-C₄)alkyl and (C₃-C₄)cycloalkyl groups; and
wherein *represents a coordination of the ligand to the platinum.

37. The cell of claim 36, wherein the support forms all or part of one or more electrode(s) of the cell.

38. The cell of claim 37, wherein the support forms all or part of an anode of the cell.

39. The cell of claim 37, wherein the electrode has a degree of platinum loading of less than or equal to 0.05 g Pt/A.
